(19) United States
(12) Patent Application Publication
(10) Pub. No.: US 2023/0286502 A1
(43) Pub. Date: Sep. 14, 2023

(54) Autonomous Driving Control Apparatus and Method for Controlling Setting Speed Thereof

(71) Applicants: Hyundai Motor Company, Seoul (KR); Kia Corporation, Seoul (KR)

(72) Inventors: Han Na Yun, Seoul (KR); Cheol Hwan Yun, Seoul (KR)

(21) Appl. No.: 17/970,037

(22) Filed: Oct. 20, 2022

(30) Foreign Application Priority Data
Mar. 11, 2022 (KR) 10-2022-0030974

(51) Int. Cl. B60W 30/14; B60W 50/10; B60W 50/14; B60W 60/00

(52) U.S. Cl. CPC B60W 30/143; B60W 50/10; B60W 50/14; B60W 60/001; B60W 2050/0063

(57) ABSTRACT

An embodiment autonomous driving control apparatus includes a set speed control panel configured to be manipulated by a user to adjust a set speed that is followed by a vehicle during autonomous driving and a processor configured to control an increase or a decrease in the set speed to set an adjusted set speed based on a manipulation direction and a manipulation angle of the set speed control panel and to control the vehicle to follow the adjusted set speed.

### CROSS-REFERENCE TO RELATED APPLICATIONS

This application claims the benefit of Korean Patent Application No. 10-2022-0030974, filed on Mar. 11, 2022, which application is hereby incorporated herein by reference.

### TECHNICAL FIELD

The present disclosure relates to an autonomous driving control apparatus and a set speed control method therefor.

### BACKGROUND

Recently, a number of people interested in autonomous vehicles is increasing. A currently commercialized autonomous vehicle is equipped with a smart cruise control (SCC) system that sets a set speed of the vehicle and controls the vehicle to drive autonomously by following the set speed or a cruise control (CC) system.

Conventionally, when changing the set speed of the SCC or the CC, a method of manipulating a tumbler switch, pressing a dedicated button, touching a speed limit displayed on a display device, or manipulating a specific switch by notifying that the speed limit is changed, etc. are applied.

However, a conventional tumbler switch for adjusting a set speed has a problem in that it is difficult to manipulate as quickly as a driver wants because a specific function must be maintained for a certain period of time after manipulation.

In addition, a conventional dedicated button method or display device touch method for adjusting the setting speed increases the cost and complexity, and is a method of providing a quick change only at the time of recognizing or changing the speed limit, which lacks continuity.

The above information disclosed in this background section is only for enhancement of understanding of the background of the disclosure, and therefore, it may contain information that does not form the prior art that is already known to a person of ordinary skill in the art.

### SUMMARY

The present disclosure relates to an autonomous driving control apparatus and a set speed control method therefor. Particular embodiments relate to a technique for changing a set speed based on a manipulation angle of a set speed control panel of an autonomous driving vehicle.

An exemplary embodiment of the present disclosure provides an autonomous driving control apparatus and a set speed control method therefor, capable of increasing user satisfaction by allowing a set speed for autonomous driving control to be set or changed quickly through manipulation of a manipulation angle of a set speed control panel.

The technical features of embodiments of the present disclosure are not limited to the features mentioned above, and other technical features not mentioned can be clearly understood by those skilled in the art from the description of the claims.

An exemplary embodiment of the present disclosure provides an autonomous driving control apparatus including a set speed control panel configured to be manipulated by a user to adjust a set speed that is followed by a vehicle during autonomous driving and a processor configured to control an increase or a decrease in the set speed depending on a manipulation direction and a manipulation angle of the set speed control panel and to control the vehicle to follow the set speed.

In an exemplary embodiment, the processor may determine increasing manipulation or decreasing manipulation depending on the manipulation direction of the set speed control panel.

In an exemplary embodiment, the processor, when the increasing manipulation of the set speed control panel is performed, may determine whether the manipulation angle of the set speed control panel is smaller than a predetermined first reference value.

In an exemplary embodiment, the processor may determine whether the manipulation angle of the set speed control panel is smaller than a second reference value that is greater than the first reference value when the manipulation angle of the set speed control panel is greater than or equal to the predetermined first reference value.

In an exemplary embodiment, the processor may increase the set speed by a first predetermined unit when the manipulation angle of the set speed control panel is greater than or equal to the first reference value and is smaller than the second reference value.

In an exemplary embodiment, the processor may determine whether the manipulation angle of the set speed control panel is equal to or greater than the second reference value and smaller than a third reference value that is greater than the second reference value when the manipulation angle of the set speed control panel is greater than or equal to the second reference value.

In an exemplary embodiment, the processor may increase the set speed by a second unit that is greater than the first unit when the manipulation angle of the set speed control panel is greater than or equal to the second reference value and is smaller than the third reference value.

In an exemplary embodiment, the processor may determine whether a current set speed is smaller than a speed limit of a driving road when the manipulation angle of the set speed control panel is equal to or greater than the third reference value.

In an exemplary embodiment, the processor may change the current set speed to the speed limit of the driving road when the current set speed is smaller than the speed limit of the driving road.

In an exemplary embodiment, the processor, when the decreasing manipulation of the set speed control panel is performed, may determine whether the manipulation angle of the set speed control panel is smaller than a predetermined first reference value, may determine whether the manipulation angle of the set speed control panel is smaller than a second reference value that is greater than the first reference value when the manipulation angle of the set speed control panel is greater than or equal to the predetermined first reference value, and may decrease the set speed by a first predetermined unit when the manipulation angle of the set speed control panel is greater than or equal to the first reference value and is smaller than the second reference value.

In an exemplary embodiment, the processor may determine whether the manipulation angle of the set speed control panel is equal to or greater than the second reference value and smaller than a third reference value that is greater than the second reference value when the manipulation angle of the set speed control panel is greater than or equal to the second reference value, and may decrease the set speed by a second unit that is greater than the first unit when the manipulation angle of the set speed control panel is greater than or equal to the second reference value and is smaller than the third reference value.

In an exemplary embodiment, the processor may determine whether a current set speed exceeds a speed limit of a driving road when the manipulation angle of the set speed control panel is equal to or greater than the third reference value.

In an exemplary embodiment, the processor may change the current set speed to the speed limit of the driving road when the current set speed exceeds the speed limit of the driving road.

In an exemplary embodiment, the set speed control panel may include at least one of a ball-type scroll switch, a roll-type scroll switch, a lever switch, a left-right rotation scroll switch, or a touch screen.

In an exemplary embodiment, the processor may determine increasing manipulation or decreasing manipulation of the set speed control panel by determining at least one of a manipulation angle, a number of pulses, or an on-off time of a contact of the set speed control panel at a predetermined time interval.

In an exemplary embodiment, the autonomous driving control apparatus may further include an interface device configured to display a current set speed or a changed set speed.

An exemplary embodiment of the present disclosure provides a setting speed control method including receiving a manipulation input from a user through a set speed control panel to adjust a set speed that is followed by a vehicle during autonomous driving and controlling an increase or decrease in the set speed depending on a manipulation direction and a manipulation angle of the set speed control panel and controlling the vehicle to follow the set speed.

In an exemplary embodiment, the controlling of the vehicle to follow the set speed may include determining increasing manipulation or decreasing manipulation depending on the manipulation direction of the set speed control panel.

In an exemplary embodiment, the controlling of the vehicle to follow the set speed may include, when the increasing manipulation of the set speed control panel is performed, determining whether the manipulation angle of the set speed control panel is smaller than a predetermined first reference value, determining whether the manipulation angle of the set speed control panel is smaller than a second reference value that is greater than the first reference value when the manipulation angle of the set speed control panel is greater than or equal to the predetermined first reference value, increasing the set speed by a first predetermined unit when the manipulation angle of the set speed control panel is greater than or equal to the first reference value and is smaller than the second reference value, determining whether the manipulation angle of the set speed control panel is equal to or greater than the second reference value and smaller than a third reference value that is greater than the second reference value when the manipulation angle of the set speed control panel is greater than or equal to the second reference value, increasing the set speed by a second unit that is greater than the first unit when the manipulation angle of the set speed control panel is greater than or equal to the second reference value and is smaller than the third reference value, determining whether a current set speed is smaller than a speed limit of a driving road when the manipulation angle of the set speed control panel is equal to or greater than the third reference value, and changing the current set speed to the speed limit of the driving road when the current set speed is smaller than the speed limit of the driving road.

In an exemplary embodiment, the controlling of the vehicle to follow the set speed may include, when the decreasing manipulation of the set speed control panel is performed, determining whether the manipulation angle of the set speed control panel is smaller than a predetermined first reference value, determining whether the manipulation angle of the set speed control panel is smaller than a second reference value that is greater than the first reference value when the manipulation angle of the set speed control panel is greater than or equal to the predetermined first reference value, decreasing the set speed by a first predetermined unit when the manipulation angle of the set speed control panel is greater than or equal to the first reference value and is smaller than the second reference value, determining whether the manipulation angle of the set speed control panel is equal to or greater than the second reference value and smaller than a third reference value that is greater than the second reference value when the manipulation angle of the set speed control panel is greater than or equal to the second reference value, decreasing the set speed by a second unit that is greater than the first unit when the manipulation angle of the set speed control panel is greater than or equal to the second reference value and is smaller than the third reference value, determining whether a current set speed exceeds a speed limit of a driving road when the manipulation angle of the set speed control panel is equal to or greater than the third reference value, and changing the current set speed to the speed limit of the driving road when the current set speed exceeds the speed limit of the driving road.

According to embodiments of the present technique, it is possible to increase user satisfaction by allowing a set speed for autonomous driving control to be set or changed quickly through manipulation of a manipulation angle of a set speed control panel.

In addition, various effects that can be directly or indirectly identified through this document may be provided.

### BRIEF DESCRIPTION OF THE DRAWINGS

FIG. 1 illustrates a block diagram showing a configuration of an autonomous vehicle including an autonomous driving control apparatus according to an exemplary embodiment of the present disclosure.

FIG. 2 illustrates an example of a set speed switch according to an exemplary embodiment of the present disclosure.

FIG. 3 illustrates an example of a set speed switch according to another exemplary embodiment of the present disclosure.

FIG. 4 and FIG. 5 each illustrate a flowchart showing a set speed control method during autonomous driving control according to exemplary embodiments of the present disclosure.

FIG. 6 illustrates a computing system according to an exemplary embodiment of the present disclosure.

### DETAILED DESCRIPTION OF ILLUSTRATIVE EMBODIMENTS

Hereinafter, some exemplary embodiments of the present disclosure will be described in detail with reference to exemplary drawings. It should be noted that in adding reference numerals to constituent elements of each drawing, the same constituent elements have the same reference numerals to the extent possible even though they are indicated on different drawings. In addition, in describing exemplary embodiments of the present disclosure, when it is determined that detailed descriptions of related well-known configurations or functions interfere with understanding of the exemplary embodiments of the present disclosure, the detailed descriptions thereof will be omitted.

In describing constituent elements according to exemplary embodiments of the present disclosure, terms such as first, second, A, B, (a), and (b) may be used. These terms are only for distinguishing the constituent elements from other constituent elements, and the nature, sequences, or orders of the constituent elements are not limited by the terms. In addition, all terms used herein including technical scientific terms have the same meanings as those which are generally understood by those skilled in the technical field to which the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

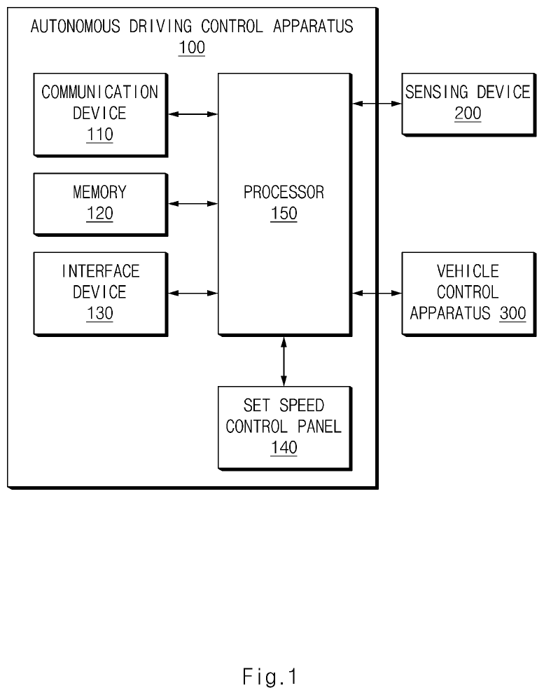

Hereinafter, exemplary embodiments of the present disclosure will be described in detail with reference to FIG. 1 to FIG. 6.

FIG. 1 illustrates a block diagram showing a configuration of an autonomous vehicle including an autonomous driving control apparatus according to an exemplary embodiment of the present disclosure.

The autonomous driving control apparatus 100 according to an exemplary embodiment of the present disclosure may be implemented inside the vehicle. In this case, the autonomous driving control apparatus 100 may be integrally formed with internal control units of the vehicle or may be implemented as a separate device to be connected to control units of the vehicle by a separate connection means. In addition, the autonomous driving control apparatus 100 may be applied to a smart cruise control (SCC) system or a cruise control (CC) system, etc., and may be applied to all autonomous vehicles using a set speed by setting or changing it.

The autonomous driving control apparatus 100 may control an increase or decrease in a set speed depending on a manipulation direction and a manipulation angle of a set speed control panel 140 manipulated by a user and may control the vehicle to follow the set speed. In this case, the set speed is a speed that is set for an autonomous vehicle to follow for autonomous driving, and the autonomous driving control apparatus 100 controls the vehicle to drive while following the set speed.

Referring to FIG. 1, the autonomous driving control apparatus 100 may include a communication device 110, a memory (i.e., a storage) 120, an interface device 130, a set speed control panel 140, and a processor 150.

The communication device no is a hardware device implemented with various electronic circuits to transmit and receive signals through a wireless or wired connection and may transmit and receive information based on in-vehicle devices and in-vehicle network communication techniques. As an example, the in-vehicle network communication techniques may include controller area network (CAN) communication, local interconnect network (LIN) communication, flex-ray communication, Ethernet communication, and the like.

In addition, the communication device no may perform communication by using a server, infrastructure, or third vehicles outside the vehicle, and the like through a wireless Internet technique or short range communication technique. Herein, the wireless Internet technique may include wireless LAN (WLAN), wireless broadband (Wibro), Wi-Fi, world interoperability for microwave access (Wimax), Ethernet communication, etc. In addition, the short-range communication technique may include Bluetooth, ZigBee, ultra wideband (UWB), radio frequency identification (RFID), infrared data association (IrDA), and the like. For example, the communication device no may receive a sensing result from a sensing device 200 to transmit it to the processor 150.

The memory 120 may store sensing results of the sensing device 200 and data and/or algorithms required for the processor 150 to operate, and the like. As an example, the memory 120 may store driving road map information, vehicle surrounding information (image data captured through a camera), a vehicle path (driving path from a start point to a destination), and the like.

The memory 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 130 may include an input means for receiving a control command from a user and an output means for outputting an operation state of the autonomous driving control apparatus 100 and results thereof. Herein, the input means may include a key button, and may further include a mouse, a touch screen, a joystick, a jog shuttle, a stylus pen, and the like. In addition, the input means may further include a soft key implemented on the display.

The output means may include a display, and may further include a voice output means such as a speaker. In this case, when a touch sensor formed of a touch film, a touch sheet, or a touch pad is provided on the display, the display may operate as a touch screen, and may be implemented in a form in which an input device and an output device are integrated. In this case, the display may include at least one of a liquid crystal display (LCD), a thin film transistor liquid crystal display (TFT LCD), an organic light emitting diode display (OLED display), a flexible display, a field emission display (FED), or a 3D display. As an example, the interface device 130 may be implemented as a head-up display (HUD), a cluster, an audio video navigation (AVN), a human machine interface (HMI), a user setting menu (USM), a monitor, an AR-enabled windshield display, or the like.

For example, the interface device 130 may display an autonomous driving state, a current vehicle speed, a current set speed, a changed set speed, and the like.

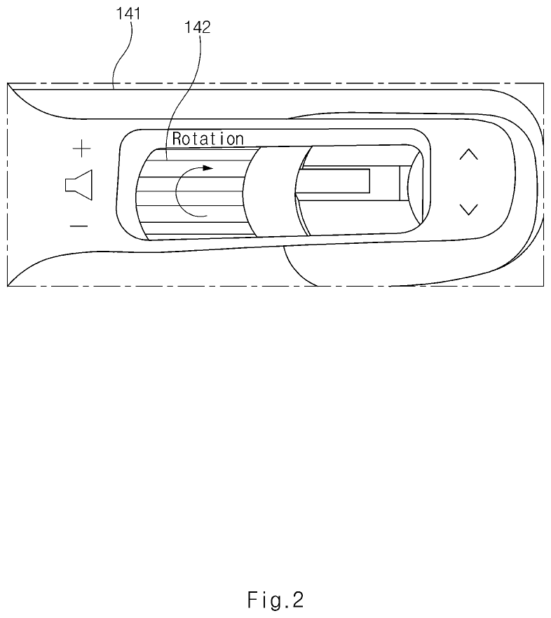

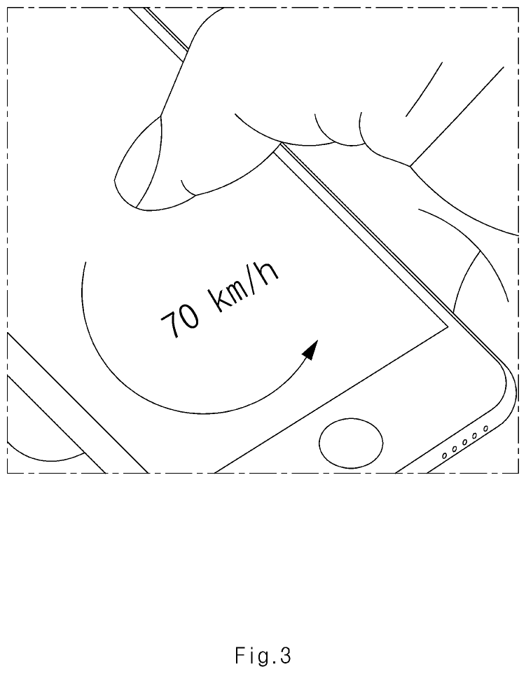

An increase or decrease in the set speed control panel 140 is manipulated by a user to determine the set speed during autonomous driving. The set speed control panel 140 may include a ball-type scroll switch, a roll-type scroll switch (e.g., mouse scroll), a lever switch, a left-right rotation scroll switch, a touch screen, and the like, for increasing or decreasing the set speed. FIG. 2 illustrates an example of a set speed switch according to an exemplary embodiment of the present disclosure, and FIG. 3 illustrates an example of a set speed switch according to another exemplary embodiment of the present disclosure. FIG. 2 illustrates a roll-type scroll switch 141 that may increase or decrease a set speed by rotating a roll 142. FIG. 3 illustrates that a setting speed may be increased or decreased through a touch rotation in a clockwise or counterclockwise direction within a touch screen.

When the set speed control panel 140 is a lever switch, an increase or decrease in the set speed may be determined using an angle at which a rotating portion of the lever switch rotates up or down.

In addition, when the set speed control panel 140 is a touch screen, the increase or decrease in the set speed may be determined by using an angle at which subsequent touch is made in a clockwise or counterclockwise direction. For example, it may be determined that manipulation is performed in a direction for increasing the set speed when the touched finger moves in the clockwise direction, and the manipulation is performed in a direction for decreasing the set speed when the touched finger moves in the counterclockwise direction.

The processor 150 may adjust a threshold value (θ0, θ1, θ2) based on a manipulation angle, a number of pulses, an on-off time of a contact, etc. of the set speed control panel 140.

The processor 150 may be electrically connected to the communication device 110, the memory 120, the interface device 130, the set speed control panel 140, and the like, may electrically control each component, and may be an electrical circuit that executes software commands, thereby performing various data processing and calculations described below.

The processor 150 may process a signal transferred between components of the autonomous driving control apparatus 100 and may perform overall control such that each of the components can perform its function normally. The processor 150 may be implemented in the form of hardware, software, or a combination of hardware and software, or may be implemented as a microprocessor, and it may be, e.g., an electronic control unit (ECU), a micro controller unit (MCU), or other subcontrollers mounted in the vehicle.

The processor 150 may determine a speed limit of a driving road based on map information such as navigation or road map information database (not illustrated), traffic information, or sign recognition information recognized by the sensing device 200.

The processor 150 may control the increase or decrease in the set speed by using a direction of an angle at which a switch of the set speed control panel 140 is turned for a predetermined time (monitoring time) of the set speed control panel 140 and may determine a magnitude of the increase or decrease in the set speed depending on a magnitude of an angle at which the switch of the set speed control panel 140 is turned.

That is, the processor 150 may control the increase or decrease in the set speed depending on a manipulation direction and a manipulation angle of a set speed control panel 140 manipulated by a user and may control the vehicle to follow the set speed.

The processor 150 may determine increasing manipulation or decreasing manipulation of the set speed control panel 140 by determining at least one of a manipulation angle, a number of pulses, or an on-off time of a contact of the set speed control panel 140 at a predetermined time interval.

The processor 150 may determine whether the manipulation angle of the set speed control panel 140 is smaller than a predetermined first reference value during the increasing manipulation of the set speed control panel.

Then, when the manipulation angle of the set speed control panel 140 is greater than or equal to the predetermined first reference value, the processor 150 determines whether the manipulation angle of the set speed control panel 140 is smaller than a second reference value that is greater than the first reference value.

Subsequently, when the manipulation angle of the set speed control panel 140 is greater than or equal to the first reference value and is smaller than the second reference value, the processor 150 may increase the set speed by a first predetermined unit. On the other hand, when the manipulation angle of the set speed control panel 140 is greater than or equal to the second reference value, the processor 150 may determine whether the manipulation angle of the set speed control panel 140 is greater than or equal to the second reference value and is smaller than a third reference value, and when the manipulation angle of the set speed control panel 140 is greater than or equal to the second reference value and is smaller than the third reference value, may increase the setting speed by a second unit that is larger than the first unit. On the other hand, when the manipulation angle of the set speed control panel 140 is greater than or equal to the third reference value, the processor 150 may determine whether a current set speed is smaller than a speed limit of a driving road, and when the current set speed is smaller than the speed limit of the driving road, may change the current set speed to the speed limit of the driving road.

In the meantime, when decreasing manipulation of the set speed control panel 140 is performed, the processor 150 may determine whether the manipulation angle of the set speed control panel 140 is smaller than the predetermined first reference value, and when the manipulation angle of the set speed control panel 140 is greater than or equal to the predetermined first reference value, may determine whether the manipulation angle of the set speed control panel 140 is smaller than a second reference value that is greater than the first reference value.

Subsequently, when the manipulation angle of the set speed control panel 140 is greater than or equal to the first reference value and is smaller than the second reference value, the processor 150 may decrease the set speed by a first predetermined unit.

On the other hand, when the manipulation angle of the set speed control panel 140 is greater than or equal to the second reference value, the processor 150 may determine whether the manipulation angle of the set speed control panel 140 is greater than or equal to the second reference value and is smaller than the third reference value, and when the manipulation angle of the set speed control panel 140 is greater than or equal to the second reference value and is smaller than the third reference value, may decrease the setting speed by a second unit that is larger than the first unit.

In the meantime, when the manipulation angle of the set speed control panel 140 is greater than or equal to the third reference value, the processor 150 may determine whether the current set speed exceeds the speed limit of the driving road, and when the current set speed exceeds the speed limit of the driving road, may change the current set speed to the speed limit of the driving road.

For example, in the case where the current set speed of the autonomous vehicle is 30 and the speed limit of the driving road is 100, when the set speed control panel 140 is manipulated in an increasing direction, the set speed may be changed as illustrated in Table 1 depending on a roll manipulation angle of the set speed control panel 140.

TABLE 1

| Manipulation angle of set speed | |
|---|---|
| control panel | Changing set speed |
| θ0 ≤ θ < θ1, t ≤ t0: | Changing set speed to 31 by +1 |
| Small angle manipulation during | |
| monitoring interval t0 | |
| θ1 ≤ θ < θ2, t ≤ t0: | Changing set speed to 40 by +10 |
| Normal angle manipulation during | |
| monitoring interval t0 | |
| θ2 ≤ θ, t ≤ t0: | Set speed < speed limit: quickly |
| Large angle manipulation during | changing set speed from 40 to 100, |
| monitoring interval t0 | which is speed limit of road |

In this case, the reference values θ0, θ1, and θ2, and the monitoring interval t0 may be variably set depending on experimental values. In addition, a charge amount (e.g., 1, 10, etc.) and a unit of the set speed depending on a case may be variably set according to the experimental values.

The autonomous driving control apparatus 100 may display the set speed on the interface device 130 as illustrated in Table 2 below.

TABLE 2

Displaying set speed (unit omitted)

| Case | Existing | Change |
|---|---|---|
| θ0 ≤ θ < θ1, t ≤ t0 | 30 | 31 |
| θ1 ≤ θ < θ2, t ≤ t0 | | 40 |
| θ2 ≤ θ, t ≤ t0 | | 40 → 100 |

The sensing device 200 may detect a speed limit of a driving road by detecting a vehicle surrounding environment, e.g., sign recognition information. To this end, the sensing device 200 may include a camera or the like.

The vehicle control apparatus 300 may control a steering angle, braking, engine driving, shifting, etc. of the vehicle by interworking with the autonomous driving control apparatus 100. To this end, the vehicle control apparatus 300 may include a steering wheel, an actuator interlocked with the steering wheel, and a controller for controlling the actuator. In addition, the vehicle control apparatus 300 may include a controller for controlling a brake. The vehicle control apparatus 300 may include a controller for controlling a speed of the vehicle.

As such, according to embodiments of the present disclosure, it is possible to control the vehicle to follow a predetermined set speed during autonomous driving, and in this case, the set speed may be changed based on the manipulation of the set speed control panel 140 and a road speed limit. In particular, according to embodiments of the present disclosure, it is possible to change the set speed quickly and simply by using a scroll switch type of a set speed control panel, thereby increasing user convenience and increasing reliability of an autonomous vehicle.

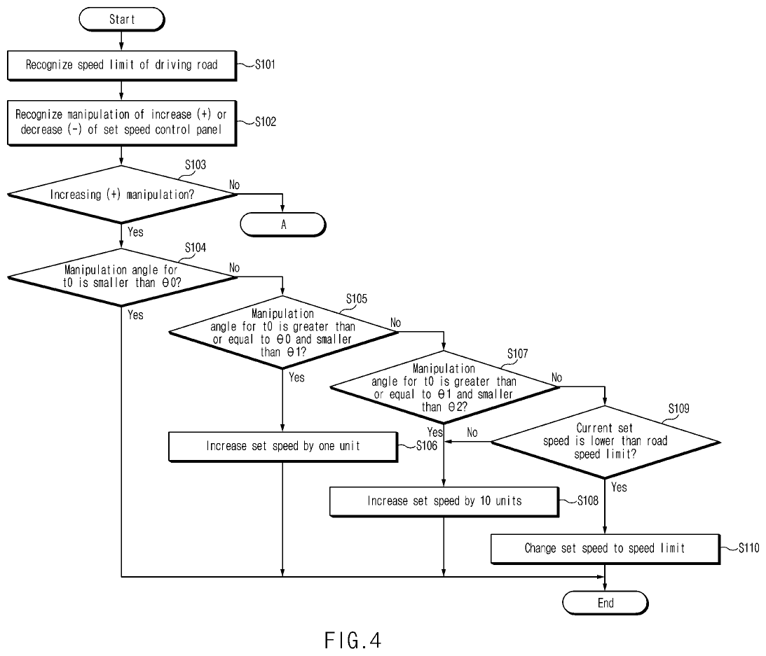

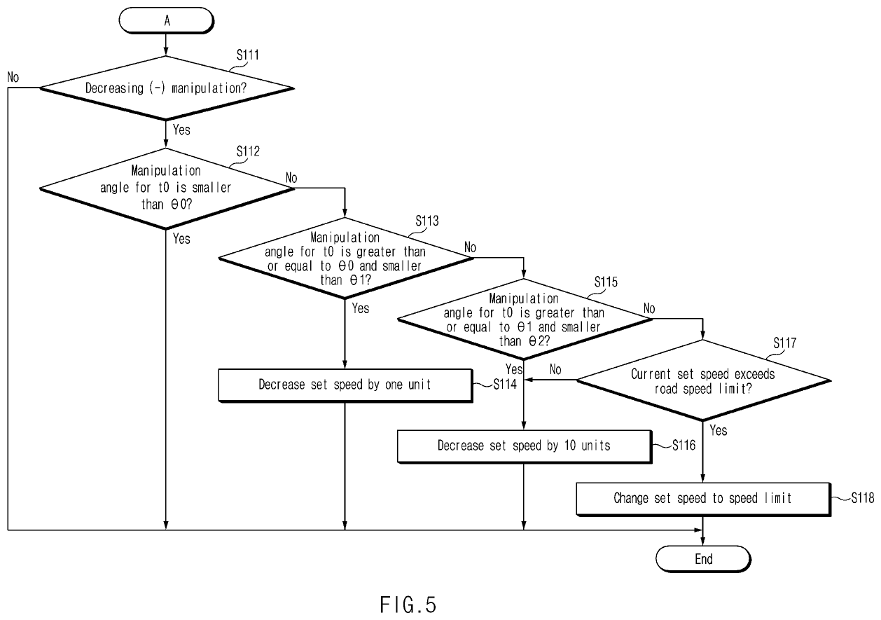

Hereinafter, a set speed control method according to an exemplary embodiment of the present disclosure will be described in detail with reference to FIG. 4 and FIG. 5. FIG. 4 and FIG. 5 each illustrate a flowchart showing a set speed control method during autonomous driving control according to an exemplary embodiment of the present disclosure. Hereinafter, it is assumed that the autonomous driving control apparatus 100 of FIG. 1 performs the processes of FIG. 4 and FIG. 5. In addition, in the description of FIG. 4 and FIG. 5, operations described as being performed by the device may be understood as being controlled by the processor 150 of the autonomous driving control apparatus 100.

Referring to FIG. 4, the autonomous driving control apparatus 100 recognizes a speed limit of a driving road (S101). The autonomous driving control apparatus 100 may recognize a speed limit of a driving road based on a sensing result of the sensing device 200 or map information or traffic information of a navigation system (not illustrated).

The autonomous driving control apparatus 100 recognizes a manipulation state (increase or decrease) of the set speed control panel 140 (S102).

Next, the autonomous driving control apparatus 100 determines whether manipulation of the set speed control panel 140 for increasing the set speed has been performed (S103). That is, when the roll 142 of the roll switch 141 of FIG. 2 is manipulated in an upward direction, it may be determined that an increasing manipulation has been performed, and when the roll 142 of the roll switch 141 moves in a downward direction, it may be determined that a decreasing direction has been performed.

When the manipulation of the set speed control panel 140 for increasing the set speed is performed, it determines whether a manipulation angle of a roll of the set speed control panel 140 for a predetermined time to is smaller than a first reference value (θ0) (S104).

When the manipulation angle of the roll of the set speed control panel 140 is not smaller than the first reference value, the autonomous driving control apparatus 100 determines whether the manipulation angle of the roll of the set speed control panel 140 is greater than or equal to the first reference value and smaller than the second reference value (θ1) (S105).

When the manipulation angle of the roll of the set speed control panel 140 is greater than or equal to the first reference value and smaller than the second reference value (θ1), the autonomous driving control apparatus 100 increases the set speed by one unit (S106).

On the other hand, when the manipulation angle of the roll of the set speed control panel 140 is not smaller than the first reference value and is not smaller than the second reference value (θ1), the autonomous driving control apparatus 100 determines whether the manipulation angle of the roll of the set speed control panel 140 is greater than or equal to the second reference value and smaller than a third reference value (θ2) (S107).

When the manipulation angle of the roll of the set speed control panel 140 is greater than or equal to the second reference value and smaller than the third reference value (θ2), the autonomous driving control apparatus 100 increases the set speed by 10 units (S108).

When the manipulation angle of the roll of the set speed control panel 140 is not greater than or equal to the second reference value and is not smaller than the third reference value (θ2), the autonomous driving control apparatus 100 determines whether a current set speed is lower than a road speed limit (S109).

When the current set speed is lower than the road speed limit, the autonomous driving control apparatus 100 changes the set speed to the road speed limit (Silo). When the current set speed is not lower than the road speed limit, the autonomous driving control apparatus 100 increases the set speed by 10 units (S108).

On the other hand, when the manipulation of the set speed control panel 140 for increasing the set speed in step S103 is not performed, it proceeds as illustrated in FIG. 5.

Referring to FIG. 5, the autonomous driving control apparatus 100 determines whether the manipulation of the set speed control panel 140 is for decreasing the speed (Sill). That is, when the roll manipulation of the predetermined speed control panel 140 moves in a direction that is opposite to an increasing direction, it may be determined that the manipulation for decreasing it is performed.

When the manipulation of the set speed control panel 140 for decreasing the set speed is performed, the autonomous driving control apparatus 100 determines whether a manipulation angle of a roll of the set speed control panel 140 for a predetermined time to is smaller than a first reference value (θ0) (S112). In this case, the first reference value (00) indicates an angle from a zero point in the direction that is opposite to the increasing direction, and hereinafter, both the second reference value and the third reference value refer to angles from the zero point in the direction that is opposite to the increasing direction.

When the manipulation angle of the roll of the set speed control panel 140 is not smaller than the first reference value, the autonomous driving control apparatus 100 determines whether the manipulation angle of the roll of the set speed control panel 140 is greater than or equal to the first reference value and smaller than the second reference value (θ1) (S113).

When the manipulation angle of the roll of the set speed control panel 140 is greater than or equal to the first reference value and smaller than the second reference value, the autonomous driving control apparatus 100 decreases the set speed by one unit (S114).

On the other hand, when the manipulation angle of the roll of the set speed control panel 140 is not greater than or equal to the first reference value and is not smaller than the second reference value (θ1), the autonomous driving control apparatus 100 determines whether the manipulation angle of the roll of the set speed control panel 140 is greater than or equal to the second reference value and smaller than a third reference value (θ2) (S115).

When the manipulation angle of the roll of the set speed control panel 140 is greater than or equal to the second reference value and smaller than the third reference value (θ2), the autonomous driving control apparatus 100 decreases the set speed by 10 units (S116).

When the manipulation angle of the roll of the set speed control panel 140 is not greater than or equal to the second reference value and is not smaller than the third reference value (θ2), the autonomous driving control apparatus 100 determines whether a current set speed exceeds a road speed limit (S117).

When the current set speed exceeds the road speed limit, the autonomous driving control apparatus 100 changes the set speed to the road speed limit (S118). When the current set speed does not exceed the road speed limit, the autonomous driving control apparatus 100 decreases the set speed by 10 units (S116). The second reference value may be set to be greater than the first reference value, and the third reference value may be set to be greater than the first reference value. In addition, the autonomous driving control apparatus 100 may check a manipulation angle of a scroll switch every predetermined time (interval).

As such, according to embodiments of the present disclosure, when the set speed of the autonomous driving function is changed, it may be manipulated in a significantly shorter time compared to an existing manipulation method by operating it depending on a specific angle instead of manipulating it for a certain period of time, and thus it may allow a user to change the speed immediately by manipulating it as quickly as the user wants, thereby increasing productivity.

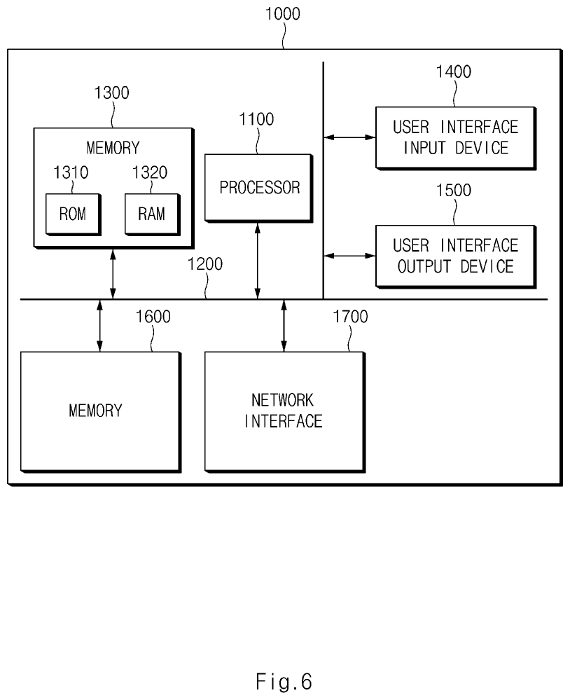

FIG. 6 illustrates a computing system according to an exemplary embodiment of the present disclosure.

Referring to FIG. 6, the computing system 1000 includes at least one processor 1100 connected through a bus 1200, a memory 1300, a user interface input device 1400, a user interface output device 1500, and a memory (i.e., a storage) 1600, and a network interface 1700.

The processor 1100 may be a central processing unit (CPU) or a semiconductor device that performs processing on commands stored in the memory 1300 and/or the memory 1600. The memory 1300 and the memory 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments disclosed herein may be directly implemented by hardware, a software module, or a combination of the two, executed by the processor 1100. The software module may reside in a storage medium (i.e., the memory 1300 and/or the memory 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of embodiments of the present disclosure, and those skilled in the art to which the present disclosure pertains may make various modifications and variations without departing from the essential characteristics of embodiments of the present disclosure.

Therefore, the exemplary embodiments disclosed in the present disclosure are not intended to limit the technical ideas of the present disclosure, but to explain them, and the scope of the technical ideas of the present disclosure is not limited by these exemplary embodiments. The protection range of the present disclosure should be interpreted by the claims below, and all technical ideas within the equivalent range should be interpreted as being included in the scope of the present disclosure.

What is claimed is:

1. An autonomous driving control apparatus comprising:
a set speed control panel configured to be manipulated by a user to adjust a set speed that is followed by a vehicle during autonomous driving; and
a processor configured to control an increase or a decrease in the set speed to set an adjusted set speed based on a manipulation direction and a manipulation angle of the set speed control panel and to control the vehicle to follow the adjusted set speed.

2. The autonomous driving control apparatus of claim 1, wherein the processor is configured to determine whether a manipulation is an increasing manipulation or a decreasing manipulation based on the manipulation direction of the set speed control panel.

3. The autonomous driving control apparatus of claim 2, wherein, in response to a determination that the manipulation is the increasing manipulation, the processor is configured to determine whether the manipulation angle of the set speed control panel is smaller than a predetermined first reference value.

4. The autonomous driving control apparatus of claim 3, wherein, in response to a determination that the manipulation angle of the set speed control panel is not smaller than the predetermined first reference value, the processor is configured to determine whether the manipulation angle of the set speed control panel is smaller than a second reference value that is greater than the predetermined first reference value.

5. The autonomous driving control apparatus of claim 4, wherein, in response to a determination that the manipulation angle of the set speed control panel is not smaller than the predetermined first reference value but is smaller than the second reference value, the processor is configured to increase the set speed by a first predetermined unit.

6. The autonomous driving control apparatus of claim 5, wherein, in response to a determination that the manipulation angle of the set speed control panel is not smaller than the second reference value, the processor is configured to determine whether the manipulation angle of the set speed control panel is smaller than a third reference value that is greater than the second reference value.

7. The autonomous driving control apparatus of claim 6, wherein, in response to a determination that the manipulation angle of the set speed control panel is not smaller than the second reference value but is smaller than the third reference value, the processor is configured to increase the set speed by a second unit that is greater than the first predetermined unit.

8. The autonomous driving control apparatus of claim 6, wherein, in response to a determination that the manipulation angle of the set speed control panel is not smaller than the third reference value, the processor is configured to determine whether a current set speed is less than a speed limit of a driving road.

9. The autonomous driving control apparatus of claim 8, wherein, in response to a determination that the current set speed is less than the speed limit of the driving road, the processor is configured to change the current set speed to the speed limit of the driving road.

10. The autonomous driving control apparatus of claim 2, wherein, in response to a determination that the manipulation is the decreasing manipulation, the processor is configured to:
determine whether the manipulation angle of the set speed control panel is smaller than a predetermined first reference value;
in response to a determination that the manipulation angle of the set speed control panel is not smaller than the predetermined first reference value, determine whether the manipulation angle of the set speed control panel is smaller than a second reference value that is greater than the predetermined first reference value; and
in response to a determination that the manipulation angle of the set speed control panel is not smaller than the predetermined first reference value but is smaller than the second reference value, decrease the set speed by a first predetermined unit.

11. The autonomous driving control apparatus of claim 10, wherein the processor is configured to:
in response to a determination that the manipulation angle of the set speed control panel is not smaller than the second reference value, determine whether the manipulation angle of the set speed control panel is smaller than a third reference value that is greater than the second reference value; and
in response to a determination that the manipulation angle of the set speed control panel is not smaller than the second reference value but is smaller than the third reference value, decrease the set speed by a second unit that is greater than the first predetermined unit.

12. The autonomous driving control apparatus of claim 11, wherein, in response to a determination that the manipulation angle of the set speed control panel is not smaller than the third reference value, the processor is configured to determine whether a current set speed exceeds a speed limit of a driving road.

13. The autonomous driving control apparatus of claim 12, wherein, in response to a determination that the current set speed exceeds the speed limit of the driving road, the processor is configured to change the current set speed to the speed limit of the driving road.

14. The autonomous driving control apparatus of claim 1, wherein the set speed control panel comprises a ball-type scroll switch, a roll-type scroll switch, a lever switch, a left-right rotation scroll switch, or a touch screen.

15. The autonomous driving control apparatus of claim 14, wherein the processor is configured to determine whether a manipulation is an increasing manipulation or a decreasing manipulation of the set speed control panel by determining the manipulation angle, a number of pulses, or an on-off time of a contact of the set speed control panel at a predetermined time interval.

16. The autonomous driving control apparatus of claim 1, further comprising an interface device configured to display a current set speed or a changed set speed.

17. An autonomous driving control method comprising:
receiving a manipulation input from a user through a set speed control panel to adjust a set speed that is followed by a vehicle during autonomous driving; and
controlling an increase or a decrease in the set speed to set an adjusted set speed based on a manipulation direction and a manipulation angle of the set speed control panel and controlling the vehicle to follow the adjusted set speed.

18. The autonomous driving control method of claim 17, wherein controlling the vehicle to follow the adjusted set speed comprises determining whether the manipulation is an increasing manipulation or a decreasing manipulation based on the manipulation direction of the set speed control panel.

19. The autonomous driving control method of claim 18, wherein controlling the vehicle to follow the adjusted set speed comprises:
in response to a determination that the manipulation is the increasing manipulation, determining whether the manipulation angle of the set speed control panel is smaller than a predetermined first reference value;
in response to a determination that the manipulation angle of the set speed control panel is not smaller than the predetermined first reference value, determining whether the manipulation angle of the set speed control panel is smaller than a second reference value that is greater than the predetermined first reference value;
in response to a determination that the manipulation angle of the set speed control panel is not smaller than the predetermined first reference value but is smaller than the second reference value, increasing the set speed by a first predetermined unit;
in response to a determination that the manipulation angle of the set speed control panel is not smaller than the second reference value, determining whether the manipulation angle of the set speed control panel is smaller than a third reference value that is greater than the second reference value;
in response to a determination that the manipulation angle of the set speed control panel is not smaller than the second reference value but is smaller than the third reference value, increasing the set speed by a second unit that is greater than the first predetermined unit;
in response to a determination that the manipulation angle of the set speed control panel is not smaller than the third reference value, determining whether a current set speed is lower than a speed limit of a driving road; and
in response to a determination that the current set speed is lower than the speed limit of the driving road, changing the current set speed to the speed limit of the driving road.

20. The autonomous driving control method of claim 18, wherein controlling the vehicle to follow the adjusted set speed comprises:
in response to a determination that the manipulation is the decreasing manipulation, determining whether the manipulation angle of the set speed control panel is smaller than a predetermined first reference value;
in response to a determination that the manipulation angle of the set speed control panel is not smaller than the predetermined first reference value, determining whether the manipulation angle of the set speed control panel is smaller than a second reference value that is greater than the predetermined first reference value;
in response to a determination that the manipulation angle of the set speed control panel is not smaller than the predetermined first reference value but is smaller than the second reference value, decreasing the set speed by a first predetermined unit;
in response to a determination that the manipulation angle of the set speed control panel is not smaller than the second reference value, determining whether the manipulation angle of the set speed control panel is smaller than a third reference value that is greater than the second reference value;
in response to a determination that the manipulation angle of the set speed control panel is not smaller than the second reference value but is smaller than the third reference value, decreasing the set speed by a second unit that is greater than the first predetermined unit;
in response to a determination that the manipulation angle of the set speed control panel is not smaller than the third reference value, determining whether a current set speed exceeds a speed limit of a driving road; and
in response to a determination that the current set speed exceeds the speed limit of the driving road, changing the current set speed to the speed limit of the driving road.
